(19) United States
(12) Patent Application Publication
(10) Pub. No.: US 2025/0326037 A1
(43) Pub. Date: Oct. 23, 2025

(54) DEVICE AND METHOD FOR THE ADDITIVE MANUFACTURING OF A THREE-DIMENSIONAL OBJECT

(71) Applicant: a-metal AG, Zürich (CH)

(72) Inventors: Stephan STEINER, Olten (CH); Adriaan SPIERINGS, Wittenbach (CH)

(73) Assignee: a-metal AG, Zürich (CH)

(21) Appl. No.: 18/864,045

(22) PCT Filed: May 10, 2023
(86) PCT No.: PCT/EP2023/062365

§ 371 Date: Nov. 8, 2024

(30) Foreign Application Priority Data
May 11, 2022 (CH) 000565/2022

(51) Int. Cl. B22F 12/70; B22F 10/28; B22F 10/32; B22F 12/52; B33Y 10/00; B33Y 30/00; B33Y 50/02

(52) U.S. Cl. CPC B22F 12/70; B22F 10/28; B22F 10/32; B22F 12/52; B33Y 10/00; B33Y 30/00; B33Y 50/02

(57) ABSTRACT

The invention relates to a device and a method for the additive manufacturing of a three-dimensional object made of a powder build material, the device and method making it possible for the supply of build material and the distribution of the build material by means of the application means and/or the removal of reaction by-products to be synchronised. Preferably, the action means is also synchronised with the supply and removal processes. This optimises the machining process in terms of time and location as well as process robustness.

### TECHNICAL FIELD

The present invention relates to a device and a method for additively manufacturing a three-dimensional object, in particular according to L-PBF (Laser Powder Bed Fusion) technology.

### PRIOR ART

Devices for additively manufacturing physical objects on the basis of digital datasets are known. Additive manufacturing methods are used to produce a three-dimensional object. In some additive manufacturing methods, the build material or starting material is liquid. In other methods, pourable bulk material, preferably pulverulent starting material, is applied layer by layer in the form of a powder bed to a build platform, also called build-plate, and individual regions of the powder bed are solidified. The method is also called powder bed fusion method. The material in the powder bed is usually called substrate material. The starting material is also called build material. The object to be produced is also called component.

Such 3D printing methods with powder bed fusion methods are known. Pulverulent starting material is generally used and worked with a powder bed. The powder used may be a metal or a plastic.

In L-PBF technology, the powder material is melted with the aid of a laser in a build-space. If plastics powder is used, usually the build-space and the plastics powder is preferably heated up to just below the melting point, such that the laser merely has to introduce the remaining amount of energy for the processing of the powder. If metal powder is used, it is usually melted by means of the laser. The build-space may also be heated, but it does not usually need to be heated. Generally, it is filled with an inert gas, also called shielding gas, in order to avoid oxidation of the metal powder and of the melt pool. Nitrogen or argon is usually used for this. The metal powder is melted, that is to say brought from the solid to the liquid aggregate state.

Devices for additively manufacturing a three-dimensional object from a pulverulent build material usually comprise:
M1) a process chamber, in which the three-dimensional object is gradually formed;
M2) a feed means for feeding the pulverulent build material into the process chamber;
M3) an application means for applying a powder layer comprising the pulverulent build material to a target surface in a build region for the gradually formed three-dimensional object in the process chamber;
M4) a means of action for specifically allowing energy to act on selected reaction regions of the applied powder layer in order to fuse the pulverulent build material in these selected reaction regions, wherein the selected reaction regions correspond to a cross section of the three-dimensional object to be formed within the powder layer; and
M5) a discharge means for discharging reaction-byproducts, in particular volatile reaction-byproducts.

The feed means forms a powder feed. The application means preferably comprises a coater mechanism. The means of action usually comprises an energy source, preferably a laser. The discharge means preferably comprises at least one extraction unit. The build region is also called process region.

Methods for additively manufacturing a three-dimensional object from a pulverulent build material usually comprise the following steps:
S1) feeding a pulverulent build material into a process chamber;
S2) applying a powder layer comprising the pulverulent build material to a target surface in a build region or process region for the gradually formed object in the process chamber;
S3) specifically allowing energy to act on selected reaction regions of the powder layer which correspond to a cross section of the object to be formed within the powder layer, in order to fuse the pulverulent build material in the selected regions; and
S4) discharging reaction-byproducts from the powder layer, steps S1) to S3) being carried out repeatedly in order to gradually build up the object layer by layer.

In many cases, the additively manufactured objects are components which are installed in systems which comprise further components, for example in apparatuses or machines.

These additively manufactured components must therefore meet a high level of quality with respect to their structure, in particular their strength and homogeneity. Furthermore, they must exhibit a good level of dimensional accuracy, i.e. the deviations from predefined and desired geometries of the respective component must be as low as possible.

The component properties are influenced significantly by the process robustness. Byproducts from a region of action can impair this process robustness. Particularly in L-PBF technology, there are the following problems:
Interaction of fumes with the energy source, in particular with the laser:
   Due to the interaction of the energy source with produced fumes, laser energy may be absorbed. The laser light may be refracted or defocused. The beam quality may deteriorate and the laser light may be scattered. These influences lead to energetic fluctuations in the region of action, with the result that it cannot be ensured that the properties of the additively manufactured object constantly meet the set requirements.
Condensate deposits on an optical unit of the means of action, on surfaces of the object to be manufactured, on displacement shafts and in the powder bed:
   Fumes condense. These condensates consist of alloy constituents of the substrate material, i.e. of the pulverulent starting material in the powder bed. If these alloy constituents are deposited on an optical unit, for example of the laser or of deflection mirrors or lenses, the transmission of energy from the energy source to the site of action is impaired. If they are deposited on displacement shafts of the device, the movability is reduced and increased maintenance effort is required. If these condensates are deposited on the surface of the object to be formed, it results in defect inclusions/oxide inclusions in the component to be formed, which in turn impairs the component properties. Deposits in the powder bed can have the result that the powder quality is changed significantly. If the non-solidified powder is reused in a subsequent production process, the contamination of said powder may lead to losses in quality in subsequently produced objects during the subsequent use.
Weld-spatter in the powder bed:
   Weld-spatter produced in the region of action of the means of action may be considerably greater than the pulverulent starting material. If such weld-spatter lands in the powder bed, it may result in process fluctuations in the region of action within the powder bed and thus also impair the properties of the object to be formed. Furthermore, the surface of the weld-spatter is often covered with an oxidation layer. The weld-spatter therefore contaminates the powder material to be solidified and thus the resultant object. This weld-spatter can be removed only partially by a sieving process. Said weld-spatter thus contributes substantially to powder aging, i.e. the non-solidified powder in the powder bed can be reused only to a very limited extent.

Irregularities in the powder bed, i.e. in the substrate material, can also cause process fluctuations. The powder bed should therefore preferably have the following properties:
constant layer height
constant layer density
constant particle size distribution

In addition to the process robustness, i.e. to the consistent quality, the productivity is also relevant to economical production of components. Particularly in L-PBF technology, the process time is influenced by the following influencing factors:
Exposure parameters:
   a. vector distance between the individual laser paths (called hatching)
   b. power of the energy source
   c. speed of the means of action
Dead time
   a) caused during the application of the pulverulent build material, i.e. caused by the coating process
   b) caused during the production of a protective atmosphere, i.e. during the setting up and/or flooding of the process chamber.

The prior art in each case addresses only some of these problems. They deal with layer time reductions or improved local extraction of byproducts or local powder feed mechanisms.

For example, EP 3 634 757 A1 discloses a layer time reduction through simultaneous processing of multiple powder layers which are spatially offset. A local powder feed is provided. The coater is synchronized with the position of the energy source.

DE 10 2014 108061 A1 discloses a local fume extraction means close to the region of action of the means of action. However, the region of action is very small and greatly slows down the very rapid movement of the energy beam. Weld-spatter with high initial speed can therefore tend to escape from the region and still land in the powder bed.

EP 3 323 597 B1 discloses a radially arranged fume extraction means close to the region of action. Due to this arrangement, the flow profile is also oriented radially. As a result, a region over which new shielding gas only poorly flows may form close to the powder bed.

DE 10 2016 112652 A1 describes a bidirectional shielding gas flow. The feed and extraction of shielding gas at the coater serves to ensure that the shielding gas flow is always guided in the same direction and as low as possible in terms of height with respect to the powder bed. The layer time is reduced by carrying out bidirectional coating by means of a powder reservoir on the coater.

### SUMMARY OF THE INVENTION

It is therefore an object of the invention to provide an improved device and a method for additively manufacturing a three-dimensional object.

This object is achieved by a device and a method having the features of claims 1, 2 and 3 and, respectively, claim 16.

In a preferred embodiment, the device according to the invention for additively manufacturing a three-dimensional object from a pulverulent build material comprises
a process chamber, in which the three-dimensional object is able to be gradually formed;
a feed means for feeding the pulverulent build material into the process chamber;
an application means for applying a powder layer comprising the pulverulent build material to a target surface in a build region for the object to be gradually formed in the process chamber;
a means of action for specifically allowing energy (1b) to act on selected reaction regions of the powder layer in order to fuse the pulverulent build material in the selected reaction regions, wherein the selected reaction regions correspond to a cross section of the three-dimensional object to be formed within the powder layer; and
a discharge means for discharging reaction-byproducts (8) from the powder layer.

The application means and the feed means are jointly integrated in an assembly which is movable in controlled fashion within the process chamber.

The device is suitable to be used in particular for L-PBF methods, in particular for plastic and/or metal.

The application means preferably comprises a coating mechanism. The build region is also called process region. The means of action comprises an energy source, preferably a laser. Preferably, the means of action also comprises deflection mirrors for the controlled movement of the laser beam and a focusing optical unit, preferably a flat-field lens. Flat-field lenses are also called F-theta lenses.

Since the feed means is moved jointly with the application means, dead times between the application of the powder to the build-plate and the distribution of the powder over the target surface can be avoided or at least minimized. As a result, the processing process runs in a temporally optimized manner, it is not “slowed down”. The layer time, i.e. the time for applying the powder to the target surface, can be reduced in comparison to conventional systems. This increases the productivity. Weaker and thus more cost-effective lasers can also be used while still having more competitive productivity, since coating can be carried out more rapidly.

In another embodiment, the application means and the discharge means are jointly integrated in an assembly which is movable in controlled fashion within the process chamber. Preferably, the discharge means extends at least approximately over the entire length of the application means.

Due to the spatial proximity of the discharge means to the application means and due to the joint movement thereof, fumes and weld-spatter are extracted before they can cause the aforementioned problems. The optical unit of the means of action is impaired to a lesser extent by fumes, condensate deposits are minimized or avoided in all regions and weld-spatter passes to a lesser extent into the powder bed. Maintenance is minimized, the powder bed is contaminated to a lesser extent and the powder can thus be reused for longer. These advantages reduce the production costs. The advantageous effects are increased when the discharge means extends as much as possible over the entire length of the application means, i.e. extends as much as possible over the entire length of a doctor blade of the application means.

In a preferred embodiment, all three means, i.e. the application means, the feed means and the discharge means, are jointly integrated in the assembly which is movable in controlled fashion within the process chamber.

If all three of the aforementioned means are moved jointly with one another, the mentioned advantages are combined with one another. In addition, a highly compact, integrated construction of the entire device is possible. This reduces the space requirement of the device while simultaneously optimizing its mode of action.

The movable assembly is preferably arranged on a carriage which is displaceably guided. The displacement is preferably effected exclusively in the horizontal direction. The target surface is preferably stationary with respect to the horizontal. However, it is preferably adjustable in the vertical. The adjustment is preferably effected by means of the same controller which also controls the assembly. Preferably, this controller coordinates all the movements.

Preferably, a shielding-gas feed means for feeding a shielding gas into the build region is present. In some embodiments, it is arranged in a positionally fixed manner and separate from the movable assembly. In other embodiments, it is integrated in the movable assembly.

The feed means preferably comprises a powder conveyor for feeding the powder to the application means. Preferably, the powder conveyor is a conveyor belt or a differently designed conveyor section. The conveyor belt or the conveyor section is preferably driven. Preferably by means of the controller of the assembly.

The use of a shielding gas reduces instances of oxidation and thus undesired deposits. If the shielding-gas feed means is also integrated in the movable assembly, optimal feed and distribution of the shielding gas in the region of action is ensured. It is also advantageous that less shielding gas is consumed or required. This also reduces the operating costs.

Preferably, the shielding-gas feed means contains a shielding-gas metering unit for the metered feeding of the shielding gas to the target surface in the build region or process region of the process chamber. The metering of the shielding gas ensures optimal avoidance of oxidation while simultaneously minimizing the consumption of the shielding gas.

Preferably, the discharge means contains a reaction-byproduct extraction means for extracting reaction-byproducts, in particular volatile reaction-byproducts. Extraction is a simple and efficient type of discharge. Preferably, it can be controlled, such that extraction is carried out to a greater or lesser extent as required.

Preferably, the feed means contains a powder metering unit for the metered feeding of the pulverulent build material to the target surface in the build region or process region of the process chamber. This also optimizes the time required, shortens the production time and homogenizes the powder bed properties.

Preferably, the feed means, the discharge means and the application means are controllable by a common control unit. This optimizes the interaction of the individual means, shortens the processing times, minimizes oxidation, condensate deposits, interactions with the fume and minimizes contamination of the powder bed by weld-spatter.

Even more preferably, the feed means, the discharge means, the application means and the means of action are controllable by a common control unit. The optimizations and minimizations mentioned above are therefore even more pronounced.

Preferably, the positioning of the feed means and of the discharge means is adjustable relative to one another.

Depending on the nature and size of the product to be produced, optimized interaction of the feed means and of the discharge means can thus be obtained.

Preferably, the positioning of the feed means and/or of the discharge means is adjustable relative to the target surface in the build region or process region. Depending on the nature and size of the product to be produced, optimized interaction of the feed means and/or of the discharge means with the target surface can thus be obtained.

The combination of the mentioned adjustment capabilities optimizes the interaction in an even more pronounced manner.

Preferably, an energy input by the means of action is adjustable. For example, at least one of the following parameters can be adjusted: scanning speed, the laser power, the beam diameter, hatching. A further adjustable component is the relative and absolute layer thickness of the applied powder.

Preferably, the throughput of the feed means (in particular of the powder metering device) and/or of the discharge means is adjustable. The throughput of the feed means is preferably determined by the metering device. The throughput of the discharge means can be changed due to the feed quantity or speed of the gas and/or the extraction and/or due to a change in the distance between feed and discharge.

In some embodiments, at least one powder container is arranged outside the device or is connected to the feed means in the device, in particular to the metering unit, via at least one feed line. In other embodiments, the powder container is a constituent part of the device. Preferably, the powder container is thus assigned to the feed means and integrated in the assembly. This enables local storage and feed of the powder to be used.

The method according to the invention for additively manufacturing a three-dimensional object from a pulverulent build material can be carried out in particular, but not exclusively, using the device according to the invention. The method comprises at least the following steps:
a. feeding a pulverulent build material into a process chamber;
b. applying a powder layer comprising the pulverulent build material to a target surface in a build region for the object to be gradually formed in the process chamber;
c. specifically allowing energy to act on selected reaction regions of the powder layer in order to fuse the pulverulent build material in the selected regions, wherein the selected reaction regions correspond to a cross section of the object to be formed within the powder layer, and
d. discharging reaction-byproducts from the powder layer;
wherein steps b. and c. are carried out repeatedly in order to gradually build up the object layer by layer.

According to the method according to the invention, the feed means, the discharge means and the application means are controlled in synchronized fashion by means of a common control unit.

The build region forms a process region.

It should be noted that the numbering of the steps a. to d. should not be interpreted in such a way that they necessarily define an order of the method steps.

The method is suitable in particular for L-PBF methods, but can also be used for other methods.

The feed means, the discharge means and the application means are controlled such that they are moved in synchronized fashion relative to one another. Depending on the variant of the method, the three means are arranged on different components which are moved in synchronized fashion relative to one another, but separately from one another. However, in a preferred variant, they are located on a common component which in principle jointly moves all three means, said three means furthermore preferably also being moved in synchronized fashion relative to one another.

Preferably, the feed means, the discharge means, the application means and the means of action are controlled in synchronized fashion by means of the common control unit. If the means of action is also synchronized with the other means, in particular the deflection mirrors for the laser beam, spatially and temporally optimized processing of the powder bed can be achieved. For example, the extraction can take place locally at the point where the current region of action is. If the shielding-gas feed means is also synchronized correspondingly, the feed of the shielding gas can also be optimized.

Preferably, the feeding of the pulverulent build material in step a. is carried out intermittently or continuously. Preferably, the controller selects whether feeding is carried out intermittently or continuously.

Preferably, the discharging of reaction-byproducts in step d. is carried out intermittently or continuously. Preferably, the controller selects whether discharging is carried out intermittently or continuously.

Preferably, the positioning of the feed means and of the discharge means is adjusted during the method. This increases the local and timely coordination of the individual means.

Preferably, the positioning of the feed means and/or of the discharge means relative to the target surface in the build region or process region are adjusted during the method. This increases the local and timely coordination of the individual means in relation to the target surface.

Preferably, the throughput of the feed means and/or of the discharge means is adjusted during the method.

Preferably, the respective adjusting of one of the means is carried out in dependence on the setting and/or adjustment of another one of the means.

Parallelization according to the invention of the local powder feed, exposure and extraction can compensate for the slowing down of the process and reduce the layer time in comparison to conventional systems.

Synchronized extraction makes it possible to take account of the entire build region width.

A synchronization strategy between exposure, i.e. the means of action, and the powder feed and the extraction, in order to be able to carry out extraction close to the region of action, is particularly advantageous.

The method according to the invention and the device according to the invention make it possible to extract process byproducts close to the region of action, to simultaneously guide powder into the region of action, and to subject said powder to exposure with the energy source, in synchronized fashion. Thus, process byproducts are more efficiently discharged, the layer time is reduced, fluctuations in the powder bed properties are minimized and a highly compact, integrated construction is enabled.

Preferably, an integrated coating unit is present, wherein at least one extraction unit and/or a powder feed with corresponding metering unit is integrated in the layer-forming coating unit. The position of the integrated unit and the movement of the energy beam are coordinated and synchronized with one another.

Further embodiments are specified in the dependent claims.

### BRIEF DESCRIPTION OF THE DRAWINGS

Preferred embodiments of the invention will be described below on the basis of the drawings, which serve merely for explanatory purposes and are not to be interpreted as limiting. In the drawings:

FIG. 1 shows a partially cut-away perspective schematic illustration of the device according to the invention according to a first exemplary embodiment;

FIG. 2 shows a partially cut-away perspective schematic illustration of the device according to FIG. 1 with a few further details;

FIG. 3 shows a perspective illustration of the device according to the invention according to a second exemplary embodiment;

FIG. 4 shows a section through part of the device according to FIG. 3 in an enlarged illustration;

FIG. 5 shows part of the device according to FIG. 3; and

FIG. 6 shows a further section through part of the device according to FIG. 3.

### DESCRIPTION OF PREFERRED EMBODIMENTS

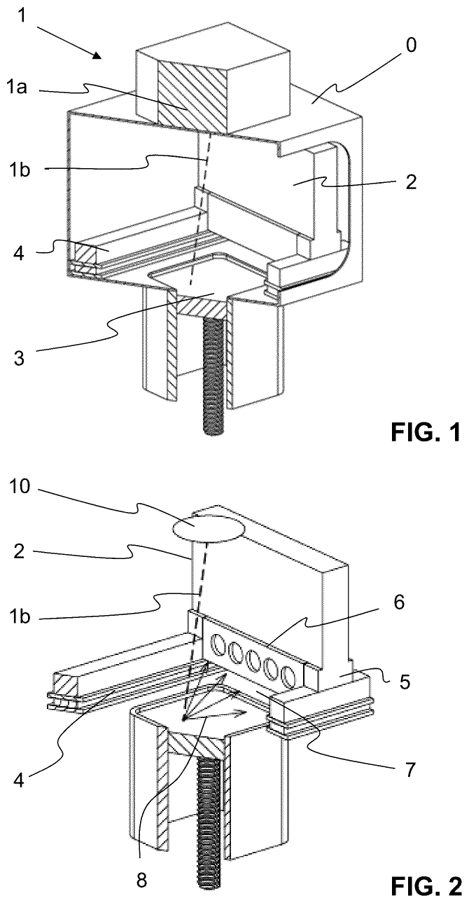

FIGS. 1 and 2 schematically illustrate the basic principle of the device according to the invention.

The device comprises a housing 0 which is preferably closed in gas-tight fashion. Arranged in the housing 0 is a build-plate 3 on which the object to be provided is produced. The build-plate 3 is adjustable in terms of height.

Arranged on the housing 0 is a means of action 1 which comprises an energy source, preferably a laser, or the feed for at least one laser beam. An energy beam deflection mechanism 1a directs and focuses an energy beam 1b of the means of action 1 onto the build-plate 3. The energy beam 1b is usually a laser beam. The reference designation 11 denotes a collimator of an externally arranged laser light source. The collimator 11 forms the outlet for the laser beam onto the movable galvo mirror.

To deflect the laser beam, motor-operated deflection mirrors are preferably arranged in the energy beam deflection mechanism 1a. They are not illustrated in the figures, but are well known in the prior art. The focusing onto the desired plane above the build-plate 3 is preferably effected by means of a flat-field lens 10, also called F-theta lens, which is preferably arranged between deflection mirror and build-plate 3. The area within which a target surface for the focused incidence of the laser beam lies is also called processing area.

Also present in the housing 0 is at least one powder container 2 which contains the pourable material to be applied, in particular the powder material 20. It is preferably metal powder. In other embodiments, it is plastic. The powder container 2 is preferably a cartridge or a cassette. The powder material can be seen in FIG. 4. Preferably, multiple powder containers 2 are present.

A feed means 5 for the feeding of the powder material 20 is also present. The feed means 5 preferably comprises valves 50 for the selective opening of the powder containers 2. In other embodiments, the valves 50 are a constituent part of the powder containers. The feed means 5 further comprises a powder conveyor 51 for conveying the powder removed from the powder container 2. The powder conveyor 50 is preferably a conveyor belt which extends below the outlets of the powder containers 2 along the powder containers 2 which are preferably arranged in a row. Other arrangements of the powder containers 2 relative to one another are possible.

The feed means 5 further comprises at least one, preferably exactly one, metering unit 52 for the metered feeding of the powder material. Such metering units are well known in the prior art. The powder conveyor 51 extends up to the metering unit 52, which is preferably located below the powder conveyor 51 such that the powder falls into the metering unit 52 due to gravity.

An application means 7 applies the powder material, which is dispensed in metered fashion and metered, to the build-plate 3. Said application means usually comprises a coating unit, also layering forming unit, which distributes the powder in controlled fashion layer by layer on the powder bed. It usually comprises or consists of at least one doctor blade. This is also known in the prior art and does not need to be explained in more detail here.

Preferably, the doctor blade is arranged in close proximity to the outlet of the metering unit 52, in order to distribute the powder falling out of or dispensed from the metering unit 52 over the build-plate 3.

The device further comprises a discharge means 6 for discharging reaction-byproducts, in particular volatile reaction-byproducts. The discharge means 6 is preferably an extraction device. Preferably, the extraction opening 60 thereof extends over the entire width of the application means 7, in particular of the doctor blade. The extraction opening 60 may be formed by multiple openings arranged in distributed fashion or a single opening.

The feed means 5, the discharge means 6 and the application means 7 are preferably jointly attached to the same assembly. Preferably, a powder container 2 or multiple powder containers 2 are also part of this assembly.

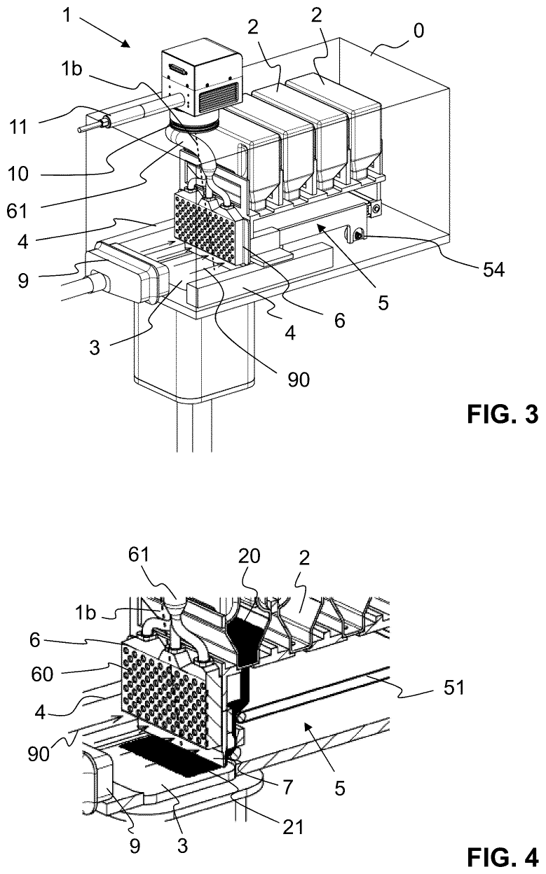

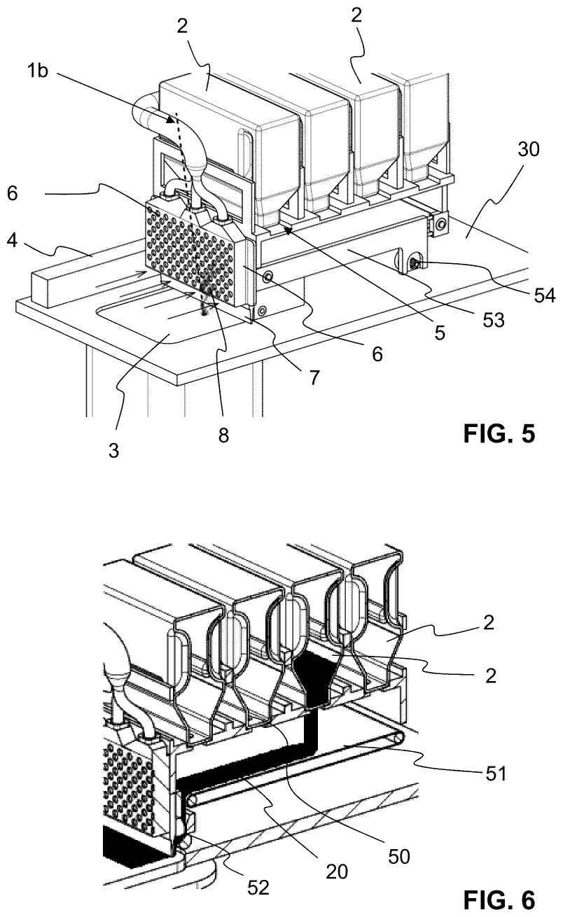

The assembly can be displaced in controlled fashion in relation to the build-plate 3. To this end, shafts 4 for guidance are preferably present and are arranged on a base plate 30 of the device. The displacement is preferably effected by means of a carriage 53 and at least one motor, which is not illustrated here. The carriage 53 is preferably displaceable by means of rollers 54 along the shafts 4. In the figures, the shafts 4 are not depicted throughout such that the rollers can be seen in FIGS. 3 and 5. Other types of translational movement of the assembly are possible and known to those skilled in the art. In some embodiments, only a translational movement is carried out; in others, a rotational movement or a pivoting movement is also carried out.

The means of action 1 is preferably arranged in a positionally fixed manner. However, the deflection mechanism 1a, in particular the deflection of the deflection mirrors, is preferably synchronized with the movement of the assembly via a controller of the device.

The individual means which are jointly integrated in the assembly can preferably be moved relative to one another, this movement also preferably being synchronized by the controller. The synchronizations are preferably each effected with regard to the build-plate 3, more precisely to the target surface in the region of the build-plate 3.

The mode of action of the device is as follows:
Powder is dispensed from the powder container 2 into the region of the build-plate 3 by means of the feed means 5 and distributed in the form of a layer on the working plate or build-plate 3 by the application means 7, in particular by the doctor blade. Exposure with the at least one energy beam 1b in the working region on the build-plate 3 melts and solidifies this layer. Subsequently, the build-plate 3 is lowered by this layer height and repositioned. The next layer is subsequently applied. The new layer is joined to the lower layer by renewed exposure. Exposure with the energy beam 1b thus makes it possible to additively build up at least one geometric object layer by layer.

The deflection mechanism 1a positions the point of engagement of the laser beam in the desired region of action or on the target surface on the build-plate 3.

The process is preferably carried out under a protective atmosphere. To this end, a shielding gas is preferably used. This will be explained in more detail below in the text on the basis of FIGS. 3 to 5.

By virtue of the use of a movable assembly, process byproducts 8, such as fumes, can be extracted close to the region of action by means of the discharge means 6, powder can be simultaneously guided into the region of action by means of the feed means 5 and the layer-forming application means 7, and said powder can be subjected to exposure with the energy beam 1b, in synchronized fashion. Thus, process byproducts 8 are more efficiently discharged, the layer time is reduced, fluctuations in the powder bed properties are minimized and a highly compact, integrated construction is enabled. The position of the integrated assembly, i.e. the unit, and the movement of the energy beam 1b are preferably coordinated and synchronized with one another.

FIGS. 3 to 5 more specifically illustrate an embodiment of the device according to the invention. The housing 0 is depicted as transparent in order to show the components arranged therein.

In comparison to the embodiment according to FIGS. 1 and 2, the shielding-gas feed means 9 is now also illustrated. It may also be arranged on the assembly and be moved jointly with the other means 5, 6, 7. However, it is preferably arranged at the end on the opposite side from the movable assembly with respect to the build-plate 3, i.e. it is arranged opposite the discharge means 6. The arrows in FIGS. 3 to 5 show the shielding gas flow 90, which thus flows areally over the build-plate 3. The shielding gas flow 90 is also called flow path. The region of action is thus flowed over by the shielding gas flow in order to discharge process byproducts. Preferably, the feed opening of the shielding-gas feed means 9 also extends over the entire width of the build-plate 3, i.e. it preferably has the same width as the discharge means 6. It may also have only one opening or multiple openings arranged in distributed fashion.

FIGS. 3 to 5 also illustrate an extraction line 61 of the discharge means 6.

Furthermore, the powder bed 21 on the build-plate 3 and the powder 20 fed from one of the powder containers 2 can readily be seen. The reaction-byproducts 8 are illustrated as fume in FIG. 5.

In this embodiment, multiple powder containers 2 are present, which are arranged one behind the other in the device and jointly integrated with the other means 5, 6, 7 in the same assembly. The assembly can be automatically displaced along the shafts 4. The corresponding motor is operated via the controller, which synchronizes this movement with the movement of the deflection mirrors for the laser beam 1b. The synchronization further includes, if necessary and mechanically provided, the movements of the metering device, powder conveyor and the valves in the feed means 5, the movement of the doctor blade of the application means 7 and the power of the discharge means 6.

The device according to the invention and the method according to the invention enable a synchronization of feed of build material and the distribution of the build material by means of the application means and/or the discharge of reaction-byproducts. Preferably, the means of action is also synchronized with the feed and discharge. This optimizes the processing process in temporal and spatial terms and the process robustness.

### LIST OF REFERENCE DESIGNATIONS

| | |
|---|---|
| 0 | Housing |
| 1 | Means of action (energy |
| | source, laser) |
| 1a | Energy beam deflection |
| | mechanism |
| 10 | Lens |
| 11 | Collimator/laser output |
| 1b | Energy, energy beam (laser |
| | beam) |
| 2 | Powder container (cartridge, |
| | cassette) |
| 20 | Powder |
| 21 | Powder bed |
| 3 | Build-plate |
| 30 | Base plate |
| 4 | Shaft (coater shaft) |
| 5 | Feed means (powder feed, |
| | powder metering unit, powder |
| | conveyor) |
| 50 | Valve |
| 51 | Powder conveyor |
| 52 | Metering unit |
| 53 | Carriage |
| 54 | Roller |
| 6 | Discharge means (extraction |
| | means) |
| 60 | Extraction opening |
| 61 | Extraction line |
| 7 | Application means (coating |
| | unit, layering forming unit) |
| 8 | Reaction-byproducts (volatile |
| | byproducts) |
| 9 | Shielding-gas feed means |
| 90 | Shielding gas flow |

1. A device for additively manufacturing a three-dimensional object from a pulverulent build material, wherein the device comprises:
a process chamber, in which the three-dimensional object is able to be gradually formed;
a feed means for feeding the pulverulent build material into the process chamber;
an application means for applying a powder layer comprising the pulverulent build material to a target surface in a build region for the object to be gradually formed in the process chamber;
a means of action for specifically allowing energy to act on selected reaction regions of the powder layer in order to fuse the pulverulent build material in the selected reaction regions, wherein the selected reaction regions correspond to a cross section of the three-dimensional object to be formed within the powder layer;
a discharge means for discharging reaction-byproducts from the powder layer,
wherein the application means and the feed means are jointly integrated in an assembly which is movable in controlled fashion within the process chamber.

2. A device for additively manufacturing a three-dimensional object from a pulverulent build material, wherein the device comprises:
a process chamber, in which the three-dimensional object is able to be gradually formed;
a feed means for feeding the pulverulent build material into the process chamber;
an application means for applying a powder layer comprising the pulverulent build material to a target surface in a build region for the object to be gradually formed in the process chamber;
a means of action for specifically allowing energy to act on selected reaction regions of the powder layer in order to fuse the pulverulent build material in the selected reaction regions, wherein the selected reaction regions correspond to a cross section of the three-dimensional object to be formed within the powder layer;
a discharge means for discharging reaction-byproducts from the powder layer, characterized in that wherein the application means and the discharge means are jointly integrated in an assembly which is movable in controlled fashion within the process chamber.

3. The device as claimed in claim 1, wherein the application means, the feed means and the discharge means are jointly integrated in the assembly which is movable in controlled fashion within the process chamber.

4. The device as claimed in claim 1, wherein the feed means comprises a powder conveyor for feeding the powder to the application means.

5. The device as claimed in claim 1, wherein the shielding-gas feed means comprises a shielding-gas metering unit for the metered feeding of the shielding gas to the target surface in the build region of the process chamber.

6. The device as claimed in claim 1, wherein the discharge means comprises a reaction-byproduct extraction means for the extraction of reaction-byproducts.

7. The device as claimed in claim 1, wherein the feed means comprises a powder metering unit for the metered feeding of the pulverulent build material to the target surface in the build region of the process chamber.

8. The device as claimed in claim 1, wherein the feed means, the discharge means and the application means are controllable by a common control unit.

9. The device as claimed in claim 1, wherein the feed means, the discharge means, the application means and the means of action are controllable by a common control unit.

10. The device as claimed in claim, wherein a positioning of the feed means and of the discharge means is adjustable relative to one another.

11. The device as claimed in claim 1, wherein a positioning of the feed means and/or of the discharge means relative to the target surface in the build region is adjustable.

12. The device as claimed in claim 1, wherein an energy input onto the selected reaction regions by the means of action is adjustable.

13. The device as claimed in claim 1, wherein a throughput of the feed means and/or of the discharge means is adjustable.

14. The device as claimed in claim 1, wherein it comprises at least one powder container.

15. The device as claimed in claim 14, wherein the powder container/containers is/are assigned to the feed means and integrated in the assembly.

16. A method for additively manufacturing a three-dimensional object from a pulverulent build material, wherein the method comprises the following steps:
a. feeding a pulverulent build material into a process chamber;
b. applying a powder layer comprising the pulverulent build material to a target surface in a build region for the object to be gradually formed in the process chamber;
c. specifically allowing energy to act on selected reaction regions of the powder layer in order to fuse the pulverulent build material in the selected regions, wherein the selected reaction regions correspond to a cross section of the object to be formed within the powder layer, and
d. discharging reaction-byproducts from the powder layer;
wherein steps b. and c. are carried out repeatedly in order to gradually build up the object layer by layer,
wherein the feed means, the discharge means and the application means are controlled in synchronized fashion by means of a common control unit.

17. The method as claimed in claim 16, wherein the feed means, the discharge means, the application means and the means of action are controlled, in particular moved, in synchronized fashion by means of the common control unit.

18. The method as claimed in claim 16, wherein the feeding of the pulverulent build material in step a. is carried out intermittently or continuously.

19. The method as claimed in claim 16, wherein the discharging of reaction-byproducts in step d. is carried out intermittently or continuously.

20. The method as claimed in claim 16, wherein the positioning of the feed means and of the discharge means are adjusted during the method.

21. The method as claimed in claim 16, wherein the positioning of the feed means and/or of the discharge means relative to the target surface in the build region are adjusted during the method.

22. The method as claimed in claim 16, wherein the throughput of the feed means and/or of the discharge means is adjusted during the method.

23. The method as claimed in claim 16, wherein the respective adjusting of one of the means is carried out in dependence on the setting and/or adjustment of another one of the means.
